(19) United States
(12) Patent Application Publication
(10) Pub. No.: US 2007/0289465 A1
(43) Pub. Date: Dec. 20, 2007

(54) Method and Device for Controlling a Processing Machine for a Sheet-Like Material

(75) Inventors: Holger Wiese, Obertshausen (DE); Bernd Lindner, Heusenstamm (DE); Helmut Schild, Steinbach/Ts (DE); Lothar Kuhlmeyer, Darmstadt (DE); Bernd Marneth, Gross-Zimmern (DE); Joachim Blumor, Hainburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN Roland Druckmaschinen AG, Offenbach (DE)

(21) Appl. No.: 11/660,061

(22) PCT Filed: Jul. 28, 2005
(86) PCT No.: PCT/EP05/08161

§ 371 Date: Mar. 27, 2007

(30) Foreign Application Priority Data
Aug. 13, 2004 (DE) 10 2004 039 588.8

(51) Int. Cl. B41F 13/20

(52) U.S. Cl. 101/375; 101/492

(57) ABSTRACT

The invention relates to a method and a device for controlling a processing machine for sheet-like material having at least one cylinder that can be driven individually and that carries a printing form. The method involves, inter alia, eliminating the pressurized printing contact between the plate cylinder 10 and adjacent rubber blanket cylinder 8 and for cleaning processes the inking unit rollers are separated on the drive side from the main drive and gear train of the sheet-guiding cylinder 6 and temporarily coupled with the directly driven plate cylinder 10. The plate cylinder 10 and inking unit rollers are driven at a first rotational speed and the rubber blanket cylinder 8 and the adjacent sheet-guiding cylinder 6 are driven at a second rotational speed by the main drive and gear train. After the cleaning process is completed, the temporary drive coupling is separated and the inking unit rollers are coupled with the main drive and gear train and the pressurized printing contact between the plate cylinder and rubber blanket cylinder is re-established.

### FIELD OF THE INVENTION

The present invention relates to a method and device for controlling a processing machine for sheet-like material that has at least one printing unit and/or coating unit.

### BACKGROUND OF THE INVENTION

A processing machine with a controllable direct drive for an individually drivable cylinder is disclosed in EP 0 812 683 A1. Such machine includes a gear train of a sheet-fed offset printing press for the transport of the sheet material via sheet-guiding cylinders. A plate cylinder or a rubber blanket cylinder of at least one printing unit can be driven directly in a predetermined manner via an individual drive that is decoupled from this gear train. In addition to specific printing corrections, the plate cylinders that can be independently driven directly by individual drives can allow other processes such as plate changes or cleaning of cylinders. The inking unit allocated to the plate cylinder has at least one roller, which can be driven with a direct motor drive. Alternatively, certain inking unit rollers are coupled on the drive side with the gear train for sheet transport via the main drive.

### BRIEF SUMMARY OF THE INVENTION

The general object of the present invention is to a create a method and a related device for substantially reducing the set-up time, particularly the cleaning time, for a processing machine for sheet-like material having at least one individually drivable cylinder carrying a printing form.

A first advantage of the invention is that it can significantly shorten the set-up time by allowing formerly individually or sequentially performed work processes, especially cleaning processes, related to a processing machine to be simultaneously combined in a controlled manner.

As a second advantage of the invention is that the cylinder (plate cylinder) carrying the printing form and the adjacent inking unit in a printing unit, preferably for cleaning, can be temporarily driven with a first rotational speed by a direct drive and that the rubber blanket cylinder and the printing cylinder constructed as a sheet-guiding cylinder can be driven with a second rotational speed by the main drive and gear train. In addition to shortening the set-up time, particularly the cleaning time, using different rotational speeds also improves the cleaning results. In particular, utilizing different rotational speeds allows the cleaning process to be more closely adapted to the type of cleaning device that is used (e.g., a blanket washing device, a brush washing device, an inking unit washing device) as well as the type of washing agent that is used.

A third advantage of the present invention is that the inking unit can be temporarily separated from the main drive and gear train of the sheet-guiding cylinder by a switchable clutch and coupled with the directly driven cylinder carrying the printing form. On the driving side, the inking unit can be operated, particularly for cleaning processes, via the directly driven cylinder carrying the printing form. After the cleaning process ends (e.g., for a production run, the drive connection of the inking unit to the directly driven cylinder carrying the printing form separates and the inking unit is re-coupled mechanically into the main drive and gear train of the sheet-guiding cylinder.

A fourth advantage of the present invention is that the cylinder (form cylinder) carrying the printing form and at least one adjacent form inking roller of the dosing device in a coating unit (preferably for cleaning) can be temporarily driven with a first rotational speed by a direct drive and the printing cylinder constructed as a sheet-guiding cylinder can be driven with a second rotational speed by the main drive and gear train. In addition to shortening the set-up time, particularly the cleaning time, using different rotational speeds also improves the cleaning results. In particular, utilizing different rotational speeds allows the cleaning process to be more closely adapted to the type of cleaning device that is used (e.g., a blanket washing device, a brush washing device, an form inking roller washing device) as well as the type of washing agent that is used.

The invention shall be explained in more detail in connection with exemplary embodiments.

### BRIEF DESCRIPTION OF THE SEVERAL VIEWS OF THE DRAWING(S)

FIG. 1 is a schematic side view of an illustrative a sheet-fed rotary printing press having several printing units and a coating unit.

FIG. 2 is a schematic partial side view of a first drive device for a cylinder carrying a printing form in an offset printing press.

FIG. 3 is a schematic partial side view of a second drive device for a cylinder carrying a printing form in an offset printing press.

FIG. 4 is a schematic partial side view of a first drive device for a cylinder carrying a printing form in a coating unit.

FIG. 5 is a schematic partial side view of a second drive device for a cylinder carrying a printing form in a coating unit.

### DETAILED DESCRIPTION OF THE INVENTION

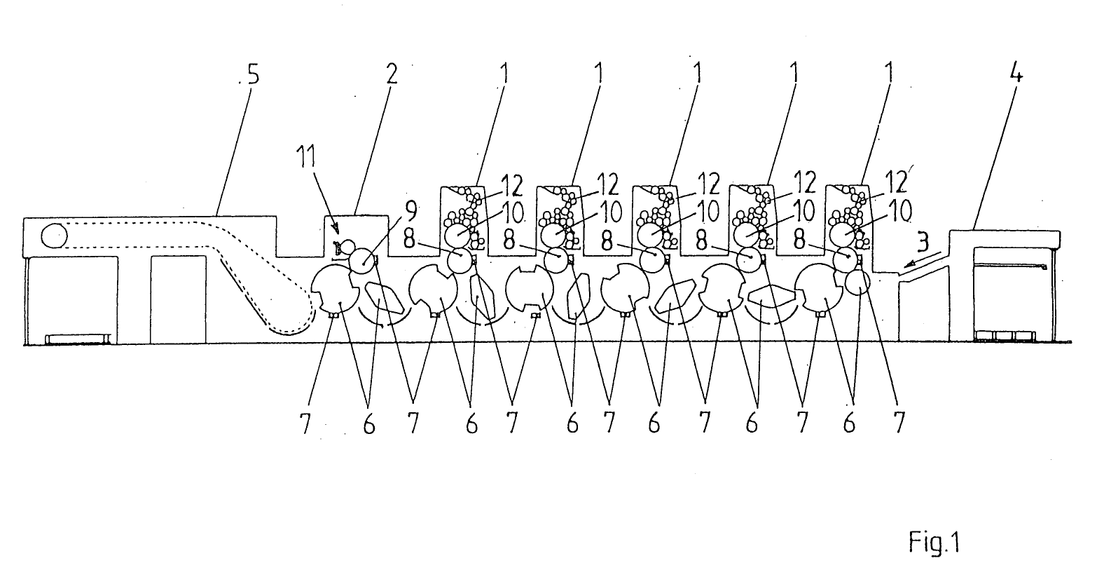

Referring to FIG. 1 of the drawings, an exemplary sheet-fed rotary printing press is shown. In this case, the printing press includes a sheet feeder 4, five offset printing units 1, a coating unit 2 and a delivery unit 5. In a known manner, each offset printing unit 1 has an inking unit 12 with inking unit rollers, a cylinder 10 carrying a printing form (in this case a plate cylinder 10) and a rubber blanket cylinder 8. When necessary, a wetting unit can be allocated to each plate cylinder 10. Also in a known manner, the coating unit 2 has a dosing device 11, preferably a chamber doctor blade with allocated screened form inking roller, for the medium to be processed (coating, ink) as well as a cylinder 9 carrying a printing form, in this case as a form cylinder 9.

The plate cylinder 10 and form cylinder 9 each carry at least one printing form and can be brought into contact with the form inking rollers of the inking unit 12 or the form inking roller of the dosing device 11. For sheet transport in a conveying direction 3, several sheet-guiding cylinders 6 are provided. Each printing or coating unit 1, 2 has a sheet-guiding cylinder 6 constructed as a printing cylinder with corresponding rubber blanket cylinder 8 or form cylinder 9 in functional connection. In the first printing unit 1, a sheet-guiding cylinder 6 in the form of a contact drum is arranged before the sheet-guiding cylinder 6 constructed as a printing cylinder. For sheet transport, additional sheet-guiding cylinders 6 in the form of transfer cylinders are arranged between the sheet-guiding cylinders 6 of the printing or coating units 1, 2 constructed as printing cylinders.

A cleaning device 7 (e.g., a blanket or brush washing device or a non-contact printing-block cleaning device) is allocated to each rubber blanket cylinder 8, form cylinder 9 and sheet-guiding cylinder 6 constructed preferably as a printing cylinder. Each inking unit 12 also has an inking unit washing device, for example, a washing agent spraying system directed onto the train of rollers. An adjustable doctor blade device is provided on a last inking unit roller in the rotational direction of the plate cylinder 10. If necessary, another cleaning device is allocated to the form inking roller or the form inking roller can be cleaned by a chamber doctor blade.

All of the sheet-guiding cylinders 6 are coupled to each other on the drive side by a main drive (at least one feeder drive motor) and a gear train. Each plate cylinder 10 and preferably each form cylinder 9 can be driven—mechanically decoupled from the main drive and gear train—by a direct drive, i.e., a separate drive motor. These direct drives M are coupled with a machine controller and can be driven individually in a predetermined manner relative to at least the sheet-guiding cylinders 6 (main drive and gear train).

The following is a description of an exemplary method for controlling at least one preferred offset printing unit 1 of a processing machine for sheet-like material. The cylinder 10 (in this case the plate cylinder 10) is supported in side stands and carries a printing form. The plate cylinder 10 is coupled with a direct drive M and decoupled mechanically from a main drive acting on the gear train of the sheet-guiding cylinder 6 for sheet transport such that the plate cylinder 10 can be driven in a predetermined manner relative to at least the sheet-guiding cylinders 6. An inking unit 12 with at least one inking unit roller that can be driven by the main drive and gear train is allocated to the directly driven plate cylinder 10. The inking unit roller is preferably an inking distribution roller that can be driven to rotate and axially movable. If necessary, a drive-side coupling can be used with additional inking unit rollers.

According to the method of the present invention, the pressurized printing contact is eliminated in a contact zone between the directly driven cylinder 10 of the offset printing unit 1, which carries the printing form and is constructed as a plate cylinder 10, and an adjacent rubber blanket cylinder 8. For cleaning, the inking unit rollers of the inking unit 12 (i.e., at least the inking distributing roller) are separated on the drive side from the sheet-guiding cylinders 6 that are driven by the main drive and gear train and are coupled temporarily (i.e., for the cleaning period) with the plate cylinder 10 that carries the printing form and is driven by the direct drive M. During the cleaning process, the plate cylinder 10 and the inking unit rollers in the inking unit 12 to be cleaned are synchronously driven at a first rotational speed. Preferably, the cleaning is performed via a known inking unit washing device.

For cleaning, the rubber blanket cylinder 8 and the adjacent sheet-guiding cylinder 6 are driven at a second rotational speed by the main drive and gear train. Preferably, the difference between the first and second rotational speed is significant. The cleaning of the rubber blanket cylinder 8 and if necessary the sheet-guiding cylinder 6 is preferably performed by a cleaning device 7 that can be moved between engaged and detached positions. If necessary, the plate cylinder 10 driven by the direct drive M and the allocated inking unit rollers can also be operated with a synchronized rotational speed relative to the rubber blanket and sheet-guiding cylinders 8, 6 driven by the main drive and gear train.

In connection with the cleaning process, the temporary drive coupling between the directly driven plate cylinder 10 and the one or more inking unit rollers of the inking unit 12 is separated and the inking unit rollers of the inking unit 12 are coupled with the direct drive and gear train of the sheet-guiding cylinder 6. The plate cylinder 10 and the rubber blanket cylinder 8 are then brought back into pressurized printing contact.

The following is a description of another exemplary method for controlling at least one preferred coating unit 2 of a processing machine for sheet-like material in which the cylinder 9 is mechanically decoupled from a main drive acting on the gear train of the sheet-guiding cylinder 6 for sheet transport. The cylinder 9 is coupled with a direct drive M and can be driven in a given way at least relative to the sheet-guiding cylinders 6. In this case, the cylinder 9 is a form cylinder that is supported in side stands and carries a printing form.

A form inking roller of a dosing device 11 for inks or coatings that can be driven by a direct drive and gear train is allocated to the cylinder 9 driven the direct drive M. Preferably, the form inking roller comprises a screen roller (anilox roller), which is operatively connected to a chamber doctor blade. The printing contact between the directly driven form cylinder 9 carrying the printing form and an adjacent sheet-guiding cylinder 6 is lifted in a contact zone. For cleaning, the form inking roller of the dosing device 11 is separated on the drive side from the sheet-guiding cylinders 6 driven by the main drive and gear train and is temporarily coupled (i.e., for the cleaning period) with the form cylinder 9 carrying the printing form and driven the direct drive M.

During the cleaning process, the form cylinder 9 driven by the direct drive M and the form inking roller of the dosing device 11 to be cleaned are synchronously driven at a first rotational speed. Preferably, the cleaning is performed by a cleaning device 7 that can be moved between engaged and detached positions relative to the form cylinder 9. For cleaning, the sheet-guiding cylinder 6 adjacent to the form cylinder 9 is driven by the main drive and gear train at a second rotational speed. In this case, the cleaning device 7 can be moved between the engaged and detached positions relative to the sheet-guiding cylinder 6 as necessary. Preferably, the difference between the first and second rotational speed is significant. If necessary, the form cylinder 9 driven by the direct drive M and the form inking roller can also be operated with a rotational speed that is synchronized relative to the sheet-guiding cylinder 6 driven the main drive and gear train.

After the cleaning process, the temporary drive coupling between the directly driven form cylinder 9 and the form inking roller of the dosing device 11 is separated and the form inking roller is coupled with the main drive and gear train of the sheet-guiding cylinder 6. The form cylinder 9 and the adjacent sheet-guiding cylinder 6 are then brought back into printing contact.

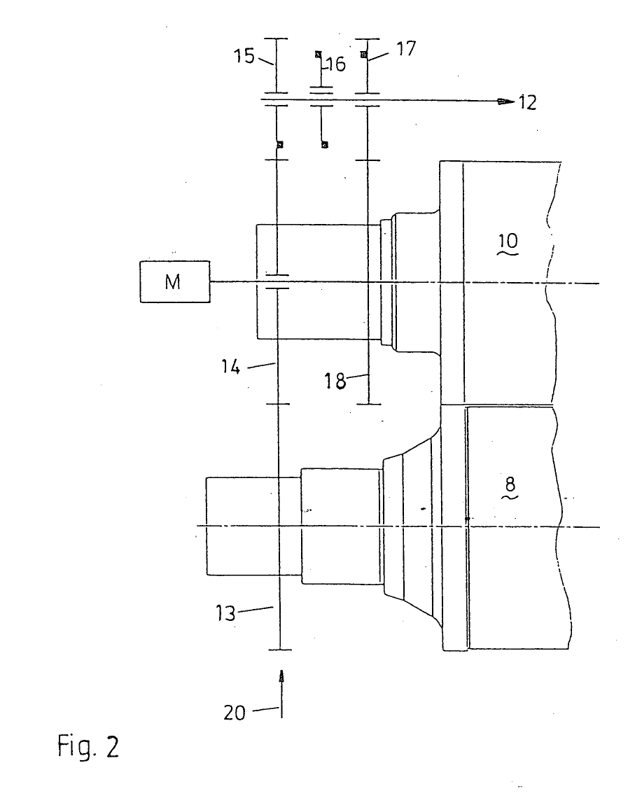

Referring to FIG. 2, a device for controlling a processing machine for sheet-like material with at least one printing and/or coating unit 1, 2 is shown. In FIG. 2, a cylinder 10 is mechanically decoupled from a main drive acting on the gear train of the sheet-guiding cylinder 6 for the sheet transport. Instead, the cylinder 10 is coupled with a direct drive M and can be driven in a predetermined manner relative to at least the sheet-guiding cylinders 6. The cylinder 10, again constructed in this case as plate cylinder 10, is supported in side stands and carries a printing form. An inking unit 12 with at least one inking unit roller that can be driven by the main drive and gear train for the sheet-guiding cylinder 6 is allocated to the directly driven plate cylinder 10. Preferably, the inking unit roller is an ink distributing roller that can be rotatably driven and axially movable.

The direct drive M includes a rotor that is detachably connected to the plate cylinder 10 carrying the printing form. The direct drive further includes a stator, which is arranged concentrically relative to the rotor and is fixed detachably on the side stand. An intermediate gear 14 is mounted so that it can rotate freely on the plate cylinder 10. A cylinder gear 18 is fixed on the plate cylinder 10 and is aligned with and at a distance from the intermediate gear 14. The intermediate gear 14 is engaged with a gear 13 which is fixed on a rubber blanket cylinder 8 arranged upstream on the drive side. A drive force 20 can be fed on the gear 13 from the sheet-guiding cylinders 6 by the main drive and gear train. The intermediate gear 14 engages on the driven side with a first gear 15 arranged so that it can rotate freely on a downstream inking unit roller (preferably at least one ink distributing roller) of the inking unit 12. A switch coupling 16 is also fixed on this inking unit roller and is aligned with and at a distance from the first gear 15. A second gear 17 is freely rotatable on the inking unit roller and is aligned with and at a distance from the switch coupling 16. The second gear 17 is engaged with the cylinder gear 18 (on the plate cylinder 10). The switch coupling 16 and also the direct drive M are coupled with the machine controller.

In a first switch position, the switch coupling 16 is coupled with the first gear 15 and the inking unit roller can be driven at a defined rotational speed by the drive 20 (via gear 13, intermediate gear 14, first gear 15) from the main drive and gear train for the sheet-guiding cylinder 6. The first switch position is preferably used for printing/coating operations. In a second switch position, the switch coupling 16 is coupled with the second gear 17 and the inking unit roller can be driven at a defined rotational speed by the direct drive M via the cylinder gear 18 (plate cylinder 10). The second switch position is preferably used for cleaning processes (wash inking unit 12, wash plate cylinder 10).

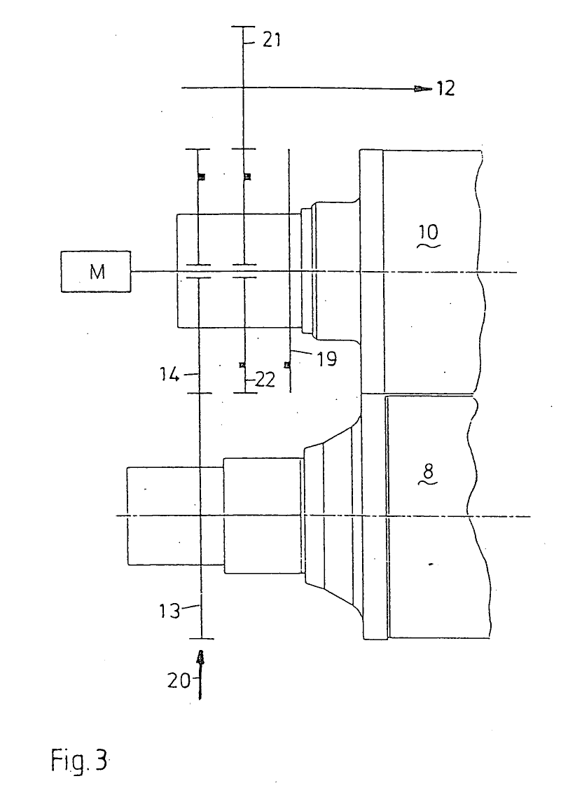

A further embodiment of a device for controlling a processing machine for sheet-like material with at least one printing and/or coating unit 1, 2 is shown in FIG. 3. In FIG. 3, a cylinder 10 is mechanically decoupled from a main drive acting on the gear train of the sheet-guiding cylinder 6 for the sheet transport. Instead, the cylinder 10 is coupled with a direct drive M can be driven in a prescribed manner relative to at least the sheet-guiding cylinders 6. The cylinder 10 in this case comprises a plate cylinder 10 and supported in side stands and carries a printing form. An inking unit 12 with at least one inking unit roller that can be driven by the main drive and gear train for the sheet-guiding cylinder 6 is allocated to the directly driven plate cylinder 10.

The direct drive M has a rotor that is detachably connected to the plate cylinder 10 carrying the printing form. The direct drive further includes a stator that is arranged concentrically relative to the rotor and is fixed detachably on the side stand. An intermediate gear 14 is supported on the plate cylinder 10 so that it can rotate freely. A gear coupling 22 is also supported so as to be freely rotatable on the plate cylinder 10 and is aligned with and at a distance from the intermediate gear 14. Furthermore, a coupling plate 19 is fixed on the plate cylinder 10 and is aligned with and at a distance from the gear coupling 22. The intermediate gear 14 is engaged with a gear 13 that is fixed on a rubber blanket cylinder 8 arranged upstream on the drive side. A drive force 20 can be fed on the gear 13 by the main drive and the gear train of the sheet-guiding cylinders 6. The gear coupling 22 is engaged on the driven side with a roller gear 21 fixed on a downstream inking unit roller of the inking unit 12. The gear coupling 22 and the direct drive M are coupled with the machine controller.

In a first switch position, the gear coupling 22 is coupled with the intermediate gear 14 and the roller gear 21 of the inking unit roller can be driven at a defined rotational speed by the drive 20 (via gear 13, intermediate gear 14, gear coupling 22) from the main drive and gear train of the sheet-guiding cylinder 6. The first switch position is preferably used for printing/coating operations. In a second switch position, the gear coupling 22 is coupled with the coupling plate 19 and the inking unit roller can be driven by the direct drive M and gear coupling 22 via the roller gear 21. This switch position is preferably used for cleaning processes (wash inking unit 12, wash plate cylinder 10).

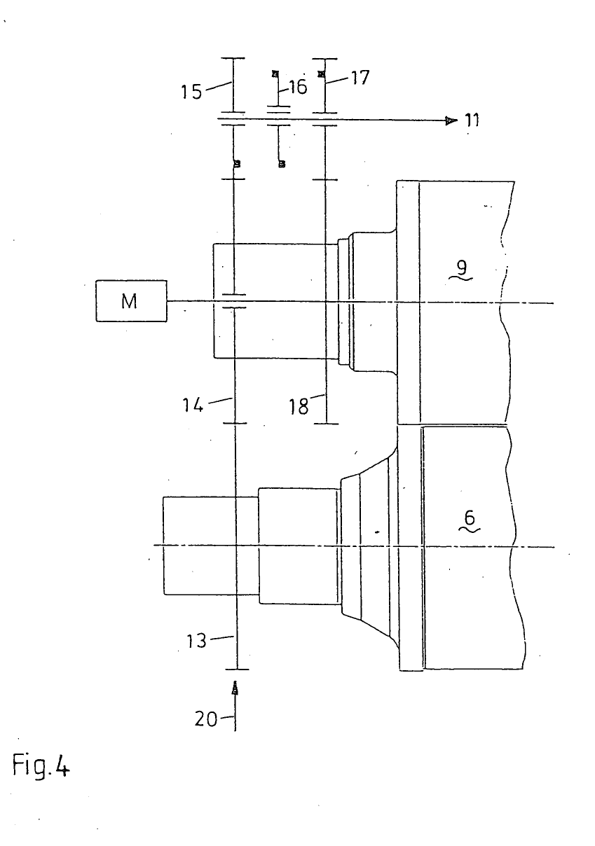

Another embodiment of a device for controlling a processing machine for sheet-like material with at least one printing and/or coating unit 1, 2 is shown in FIG. 4. In FIG. 4, a cylinder 9 is mechanically decoupled from a main drive acting on the gear train of the sheet-guiding cylinder 6 for the sheet transport. Instead, the cylinder 9 is coupled with a direct drive M and can be driven in a prescribed manner relative to at least the sheet-guiding cylinders 6. In this case, the cylinder comprises a form cylinder 9 that is supported in side stands and carries a printing form.

The direct drive M includes a rotor detachably connected to the end of the form cylinder 9 carrying the printing form. The direct drive M further includes a stator that is arranged concentrically relative to the rotor and is fixed detachably on the side stand. A form inking roller of a dosing device 11, which can be driven by a main drive and gear train, is allocated to the form cylinder 9. The form inking roller is constructed, for example, as a screen roller (anilox roller) and is operatively connected to a chamber doctor blade.

An intermediate gear 14 is mounted on the form cylinder 9 so that it can rotate freely. A cylinder gear 18 is fixed on the form cylinder 9 and is aligned with and at a distance from this intermediate gear 14. The intermediate gear 14 is engaged with a gear 13 that is fixed on a sheet-guiding cylinder 6 arranged upstream on the drive side. A drive drive force 20 can be fed on the gear 13 by the main drive and gear train from the sheet-guiding cylinders 6. The intermediate gear 14 engages on the driven side with a first gear 15 arranged so that it can rotate freely on the downstream form inking roller of the dosing device 11. A switch coupling 16 is fixed on the same form inking roller and is aligned with and at a distance from the first gear 15. A second gear 17 is arranged so that it can rotate freely and is aligned with and at a distance from the switch coupling 16. This second gear engages with the cylinder gear 18 (on the form cylinder 9). The switch coupling 16 and also the direct drive M are coupled with the machine controller.

In a first switch position, the switch coupling 16 is coupled with the first gear 15 and the form inking roller can be driven at a defined rotational speed by the drive 20 (via gear 13, intermediate gear 14, first gear 15) from the main drive and gear train for the sheet-guiding cylinder 6. The first switch position is preferably used for printing/coating operations. In a second switch position, the switch coupling 16 is coupled with the second gear 17 and the form inking roller can be driven at a defined rotational speed by the direct drive M from the cylinder gear 18 (form cylinder 9). The second switch position is preferably used for cleaning processes (wash form inking roller, wash form cylinder 9).

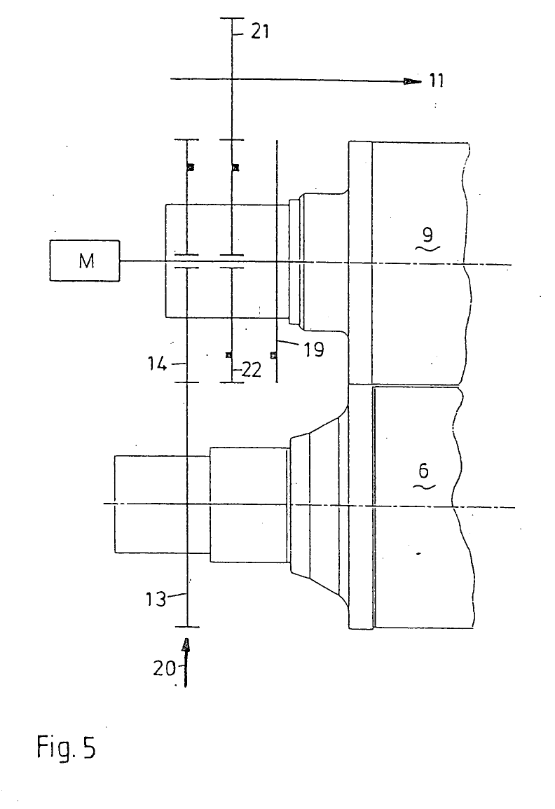

Yet another embodiment of a device for controlling a processing machine for sheet-like material with at least one printing and/or coating unit 1, 2 is shown in FIG. 5. In FIG. 5, a cylinder 9 is mechanically decoupled from a main drive acting on the gear train of the sheet-guiding cylinder 6 for sheet transport. Instead, the cylinder is coupled with a direct drive M and can be driven in a predetermined manner relative to at least the sheet-guiding cylinders 6. In this instance, the cylinder comprises a form cylinder 9 that is supported in side stands and carries a printing form.

The direct drive M includes a rotor detachably connected to the end of the form cylinder 9 carrying the printing form. The direct drive M further includes and a stator that is arranged concentrically relative to the rotor and is fixed detachably on the side stand. A form inking roller of a dosing device 11, which can be driven by a main drive and gear train, is allocated to the form cylinder 9. The form inking roller is constructed, for example, as a screen roller (anilox roller) and is operatively connected to a chamber doctor blade.

An intermediate gear 14 is supported so that it can rotate freely on the form cylinder 9 carrying the printing form. A gear coupling 22 is supported so that it can rotate freely on the form cylinder 9 and is aligned with and at a distance from the intermediate gear 14. In addition, a coupling plate 19 is fixed on the form cylinder 9 and is aligned with and at a distance from the gear coupling 22. The intermediate gear 14 engages with a gear 13 fixed on a sheet-guiding cylinder 6 which is arranged upstream on the drive side. A drive force 20 can be fed on the gear 13 by the main drive and gear train of the sheet-guiding cylinders 6. The gear coupling 22 is engaged on the driven side with a roller gear 21 fixed on the downstream form inking roller of the dosing device 11. The gear coupling 22 and the direct drive M are coupled with the machine controller.

In a first switch position, the gear coupling 22 is coupled with the intermediate gear 14, and the roller gear 21 of the form inking roller can be driven at a defined rotational speed by the drive 20 (via gear 13, intermediate gear 14, gear coupling 22) from the main drive and gear train of the sheet-guiding cylinder 6. The first switch position is preferably used for printing/coating operations. In a second switch position, the gear coupling 22 is coupled with the coupling plate 19 and the form inking roller can be driven at a defined rotational speed by the direct drive M and gear coupling 22 via the roller gear 21. The second switch position is preferably used for cleaning processes (wash form inking roller, wash form cylinder 9).

The switch couplings 16 of FIGS. 2 and 4 are not limited to the described first and second switch states. For example, the switch couplings 16 can have a third switch position in which it is decoupled from the first gear 15 and from the second gear 17. In this third switch position, the inking unit 12 or the form inking roller of the dosing device 11 is driveless. The rubber blanket cylinder 8 (FIG. 2) and the sheet-guiding cylinder 6 (FIG. 4) can be driven by the main drive and the gear train of the sheet-guiding cylinder 6. The plate cylinder 10 (FIG. 2) and the form cylinder 9 (FIG. 4) can be driven, if necessary, by means of the direct drive M.

Moreover, the gear couplings 22 of FIGS. 3 and 5 are also not limited to the described switch states. For example, the gear couplings 22 can have a third switch state in which it is decoupled from the intermediate gear 14 and the coupling plate 19. In this third switch position, the inking unit 12 or the form inking roller of the dosing device 111 is driveless. The rubber blanket cylinder 8 (FIG. 3) and the sheet-guiding cylinder 6 (FIG. 5) can be driven by the main drive and gear train of the sheet-guiding cylinder 6. The plate cylinder 10 (FIG. 3) and the form cylinder 9 (FIG. 5) can be driven, if necessary, by the direct drive M.

List of the Reference Symbols
1 Offset printing unit
2 Coating unit
3 Conveying direction
4 Feeder
5 Delivery unit
6 Sheet-guiding cylinder
7 Cleaning device
8 Rubber blanket cylinder
9 Cylinder/form cylinder carrying printing form
10 Cylinder/form cylinder carrying printing form
11 Dosing device
12 Inking unit
13 Gear
14 Intermediate gear
15 First gear
16 Switch coupling
17 Second gear
18 Cylinder gear
19 Coupling plate
20 Drive
21 Roller gear
22 Gear coupling
M Direct drive

1-8. (canceled)

9. A method for controlling a processing machine for sheet-like material with at least one printing and/or coating unit comprising the steps of:
coupling a plate cylinder in an offset printing unit that is supported in side stands and carries a printing form with a direct drive, the plate cylinder being mechanically decoupled from a main drive acting on a gear train of a sheet guiding cylinder for sheet transport and being drivable in a predetermined manner relative to the sheet-guiding cylinder, an inking unit with an inking unit roller that can be driven by the main drive and gear train being allocated to the plate cylinder;
interrupting pressure contact in a contact zone between the plate cylinder and an adjacent rubber blanket cylinder;
separating the inking unit roller of the inking unit on a drive side from the main drive and gear train and temporarily coupling the inking unit roller with the directly driven plate cylinder for cleaning;
driving the plate cylinder and the inking unit roller in sync at a first rotational speed;
driving the rubber blanket cylinder and the sheet-guiding cylinder at a second rotational speed by the main drive and gear train for cleaning; and
separating the temporary drive coupling between the plate cylinder and the inking unit roller and coupling the inking unit roller with the main drive and the gear train of the sheet-guiding cylinder and re-establishing pressure contact between the plate cylinder and the rubber blanket cylinder.

10. A method for controlling a processing machine for sheet-like material with at least one printing and/or coating unit comprising the steps of:
coupling a form cylinder that is supported in side stands and carries a printing form with a direct drive, the form cylinder being mechanically decoupled from a main drive acting on a gear train of sheet-guiding cylinders for sheet transport and being drivable in a predetermined manner relative to the sheet-guiding cylinders, a form inking roller of a dosing device that is drivable by the main drive and gear train being allocated to the form cylinder;
interrupting a pressure contact in a contact zone between the form cylinder and an adjacent sheet-guiding cylinder;
separating the form inking roller of the dosing device from the main drive and gear train and is temporarily coupling the form inking roller with the form cylinder for cleaning;
driving the form cylinder and the form inking roller of the dosing device in sync at a first rotational speed;
driving the sheet-guiding cylinder adjacent to the form cylinder at a second rotational speed by means of the main drive and gear train for cleaning; and
separating the temporary drive coupling between the form cylinder and the form inking roller of the dosing device and coupling the form inking roller with the main drive and gear train and re-establishing printing contact between the form cylinder and the adjacent sheet-guiding cylinder.

11. A device for controlling a processing machine for sheet-like material with at least one printing and/or coating unit comprising:
a cylinder supported in side stands and carrying a printing form, the cylinder being coupled with a direct drive and mechanically decoupled from a main drive acting on a gear train of a sheet-guiding cylinder for sheet transport, the cylinder being drivable in a predetermined manner relative to the sheet-guiding cylinder by the direct drive;
an inking unit including an inking unit roller that is allocated to the cylinder carrying the printing form and is drivable by the main drive and gear train, the direct drive including a rotor connected to the cylinder carrying the printing form and a stator that is arranged concentrically relative to the rotor is fixed detachably on the side stand;
an intermediate gear supported so that it can rotate freely on the cylinder carrying the printing form;
a cylinder gear fixed on the cylinder carrying the printing form and aligned with and at a distance from the intermediate gear;
a third gear engaged with the intermediate gear and fixed on an upstream rubber blanket cylinder, a drive force being feedable on the third gear by a main drive and gear train;
a first gear engaged with the intermediate gear, the first gear being arranged such that it can rotate freely on the inking unit roller;
a switch coupling fixed on the inking unit roller and aligned with and at a distance from the first gear;
a second gear engaged with the cylinder gear, the second gear being arranged so that it can rotate freely and being aligned with and at a distance from the switch coupling;
the switch coupling being movable between a first switch position wherein the switch coupling is coupled with the first gear and the inking unit roller is drivable by the drive force from the main drive and gear train and a second switch position wherein the switch coupling is coupled with the second gear and the inking unit roller is drivable by the direct drive from the cylinder gear.

12. The device according to claim 11 wherein the switch coupling is movable to a third switch position wherein the switch coupling is decoupled from the first gear (15) and the second gear.

13. A device for controlling a processing machine for sheet-like material with at least one printing and/or coating unit comprising:
a cylinder supported in side stands and carrying a printing form, the cylinder being coupled with a direct drive and mechanically decoupled from a main drive acting on a gear train of a sheet-guiding cylinder for sheet transport, the cylinder carrying the printing form being drivable in a predetermined manner relative to the sheet-guiding cylinder by the direct drive;
an inking unit with at least one inking unit roller that is allocated to the cylinder carrying the printing form and is drivable by the main drive and gear train;
the direct drive including a rotor arranged connected to the cylinder carrying the printing form and a stator arranged concentrically relative to the rotor and which is fixed detachably on the side stand,
an intermediate gear supported so that it can rotate freely on the cylinder carrying the printing form;
a gear coupling supported on the cylinder carrying the printing form so that it can rotate freely and aligned with and at a distance from the intermediate gear;
a coupling plate fixed on the cylinder and aligned with and at a distance from the gear coupling;
a third gear engaged with the intermediate gear and fixed on an upstream rubber blanket cylinder, a drive force being feedable on the third gear by the main drive and gear train;
a roller gear engaged with the gear coupling and fixed on a downstream inking unit roller of the inking unit;
the gear coupling being movable between a first switch position wherein the gear coupling is coupled with the intermediate gear and the roller gear of the inking unit roller is drivable by the drive force from the main drive and gear train and a second switch position wherein the gear coupling is coupled with the coupling plate and the inking unit roller is drivable by the direct drive via the roller gear.

14. The device according to claim 13 wherein the gear coupling is movable to a third switch position wherein the gear coupling is decoupled from the intermediate gear and the coupling plate.

15. A device for controlling a processing machine for sheet-like material with at least one printing and/or coating unit comprising:
a cylinder supported in side stands and carrying a printing form, the cylinder being coupled with a direct drive and mechanically decoupled from a main drive acting on a gear train of sheet-guiding cylinders for sheet transport and being drivable in a predetermined manner relative to the sheet-guiding cylinders;
the direct drive including a rotor connected to the cylinder carrying the printing form and a stator that is arranged concentrically relative to the rotor and is fixed detachably on the side stand;
a dosing device including a form inking roller that is allocated to the cylinder carrying the printing form and is drivable by the main drive and gear train;
an intermediate gear supported on the cylinder carrying the printing form so that it can rotate freely;
a cylinder gear fixed on the cylinder carrying the printing form and aligned with and at a distance from the intermediate gear;
a third gear engaged with the intermediate gear and fixed on an upstream sheet guide cylinder, a drive force being feedable on the third gear by the main drive and gear train;
a first gear engaged with the intermediate gear and arranged so that it can rotate freely on the form inking roller of the dosing device;
a switch coupling fixed on the inking roller and aligned with and at a distance from the first gear;
a second gear engaged with the cylinder gear, the second gear being arranged so that it can rotate freely and aligned with and at a distance from the switch coupling;
the switch coupling being movable between a first switch position wherein switch coupling is coupled with the first gear and the form inking roller is drivable by the drive force from the main drive and gear train and a second switch position wherein the switch coupling is coupled with the second gear and the form inking roller is drivable by the direct drive from the cylinder gear.

16. The device according to claim 15 wherein the switch coupling is movable to a third switch position wherein the switch coupling is decoupled from the first gear and from the second gear.

17. A device for controlling a processing machine for sheet-like material with at least one printing and/or coating unit comprising:
a cylinder supported in side stands and carrying a printing form, the cylinder being coupled with a direct drive and mechanically decoupled from a main drive acting on the gear train of the sheet-guiding cylinders for sheet transport, the cylinder being drivable in a predetermined manner relative to the sheet-guiding cylinders by the direct drive;
the direct drive including a rotor connected to the cylinder carrying the printing form and a stator that is arranged concentrically relative to the rotor and is fixed detachably on the side stand;
a dosing device including a form inking roller allocated to the cylinder carrying the printing form and being drivable by the main drive and gear train;
an intermediate gear supported so that it can rotate freely on the cylinder carrying the printing form;
a gear coupling supported on the cylinder carrying the printing form so that it can rotate freely and aligned with and at a distance from the intermediate gear;
a coupling plate fixed on the cylinder carrying the printing form and aligned with and at a distance from the gear coupling;
a third gear engaged with the intermediate gear and fixed on an upstream sheet-guiding cylinder, a drive force being feedable on the third gear can be fed by the main drive and gear train;
a roller gear engaged with the gear coupling and fixed on the form inking roller of the dosing device;
the gear coupling being movable between a first switch position wherein the gear coupling is coupled with the intermediate gear and the roller gear of the form inking roller is drivable by the drive force from the main drive and gear train and a second switch position wherein the gear coupling is coupled with the coupling plate and the form inking roller is drivable by the direct drive via the roller gear.

18. The device according to claim 17 wherein the gear coupling is movable to a third switch position wherein the gear coupling is decoupled from the intermediate gear and the coupling plate.
